(19) United States
(12) Patent Application Publication
(10) Pub. No.: US 2015/0327033 A1
(43) Pub. Date: Nov. 12, 2015

(54) ENCODING AND DECODING IN-TEXT GRAPHIC ELEMENTS IN SHORT MESSAGES

(71) Applicant: Aniways Advertising Solutions Ltd., Tel-Aviv (IL)

(72) Inventors: Daniel KALMAN, Tel-Aviv (IL); Ram GREENBERG, Tel-Aviv (IL); Shai BER, Herzlia (IL)

(21) Appl. No.: 14/706,021

(22) Filed: May 7, 2015

Related U.S. Application Data
(60) Provisional application No. 61/990,184, filed on May 8, 2014.

(51) Int. Cl. H04W 4/14

(52) U.S. Cl. CPC H04W 4/14; H04W 88/02

(57) ABSTRACT

A method of embedding zero width (ZW) Unicode sequence indicative of in-text graphic elements. The method comprises retrieving at a message transmitting client terminal a message content inputted by a user. The message content comprises text content and in-text graphic element to be embedded in line before, after or between human terms in the text content, automatically identifying in-text location of the in-text graphic element in the text content, automatically identifying at least one ZW Unicode sequence associated with the in-text graphic element, encoding a message that includes the text content and embeds the at least one ZW Unicode sequence in the in-text location, and transmitting the message to a message receiving client terminal which decodes the at least one ZW Unicode sequence for a presentation of the in-text graphic element embedded in the textual content.

### RELATED APPLICATION

This application claims the benefit of priority under 35 USC 119(e) of U.S. Provisional Patent Application No. 61/990,184 filed on May 8, 2014, the contents of which are incorporated herein by reference in their entirety.

### BACKGROUND

The present invention, in some embodiments thereof, relates to messaging and, more specifically, but not exclusively, to encoding and decoding in-text graphic elements in short messages.

In-text graphic elements, such as emoticons, animated text and/or in text graphics have acquired immense popularity and hence importance in cellular messages, such as short message service (SMS) messages or Multimedia Messaging Service (MMS) messages, for brevity referred to herein as SMS, chat room messages, instant messaging (IM) messages, and the like. The variety of available in-text graphic elements has increased tremendously, from a few types of emoticons such as “happy faces” to a multitude of elaborate and colorful animations.

SMS and IM are services available on most digital mobile phones that permit the sending of short messages between mobile phones, other handheld devices, and even landline phones. Short messaging has developed very rapidly throughout the world.

### SUMMARY

According to some embodiments of the present invention, there are provided a method of embedding one or more zero width (ZW) Unicode sequence indicative of in-text graphic elements. The method comprises retrieving at a message transmitting client terminal a message content inputted by a user and encoded as displayable data to be displayed by a messaging user interface (UI) of the message transmitting client terminal, the message content comprises text content and at least one in-text graphic element to be embedded in line before, after or between human terms in the text content, automatically identifying at least one in-text location of the at least one in-text graphic element in the text content, automatically identifying at least one ZW Unicode sequence associated with the at least one in-text graphic element, encoding a message that includes the text content and embeds the at least one ZW Unicode sequence in the at least one in-text location, and transmitting the message to a message receiving client terminal which decodes the at least one ZW Unicode sequence for a presentation of the at least one in-text graphic element embedded in the textual content.

Optionally, the retrieving is performed from a graphical user interface of the message transmitting client terminal which displays the at least one in-text graphic element embedded in the at least one in-text location of the textual content.

Optionally, the at least one ZW Unicode sequence is indicative of instructions to replace at least one human lingual term of the text content with the in-text graphic element at least at least one in-text location.

Optionally, the in-text graphic element is selected from a group consisting of a video file, an audio file, a Universal Resource Identifier (URI) element, an image, and an animation.

Optionally, the at least one ZW Unicode sequence is indicative of instructions to replace at least one human lingual term of the text content with an edited version of the at least one human lingual term.

More optionally, the edited version is at least one of a colored version of the at least one human lingual term, a highlighted version of the at least one human lingual term, an animated version of the at least one human lingual term, and a sized amended version of the at least one human lingual term.

Optionally, the at least one ZW Unicode sequence comprises a first segment which precedes confines at least one human lingual term of the text content and a second segment which succeeds the at least one human lingual term in the text content; wherein when a decoder of the message receiving client terminal reads the at least one ZW Unicode sequence the at least one lingual term is converted to a presentation of the at least one in-text graphic element in the at least one in-text location and when the decoder does not read the at least one ZW Unicode sequence, the at least one lingual term is presented in the at least one in-text location in the text content without presenting the at least one ZW Unicode sequence and the at least one in-text graphic element.

Optionally, the transmitting is performed so that when the message is decoded by a decoder set to read the at least one ZW Unicode sequence the at least one in-text graphic element is identified and presented on a display of the message receiving client terminal.

More optionally, when the message is decoded by another decoder not set to read the at least one ZW Unicode sequence, the textual content is presented without the at least one in-text graphic element and without visually presenting the at least one ZW Unicode sequence.

Optionally, the encoding comprises: identifying an inline length of the at least one in-text graphic element and adding at least one Unicode representing the inline length to the ZW Unicode sequence; and wherein the inline length is used for the decoding.

More optionally, the encoding comprises padding the ZW Unicode sequence with at least one designated Unicode based on the ZW Unicode sequence.

According to some embodiments of the present invention, there are provided a system of embedding one or more zero width (ZW) Unicode sequences indicative of in-text graphic elements. The system comprises a graphical user interface for retrieving a message content inputted by a user and encoded as displayable data to be displayed by a messaging user interface (UI) of the message transmitting client terminal, the message content comprises text content and at least one in-text graphic element to be embedded in line before, after or between human terms in the text content, a client module encoder which identifies automatically at least one in-text location of the at least one in-text graphic element in the text content and at least one ZW Unicode sequence associated with the at least one in-text graphic element, the client module encoder encodes a message that includes the text content and embeds the at least one ZW Unicode sequence in the at least one in-text location, and a network interface which transmits the message to a message receiving client terminal which decodes the at least one ZW Unicode sequence for a presentation of the at least one in-text graphic element embedded in the textual content.

According to some embodiments of the present invention, there are provided a method of decoding in-text graphic elements from a message. The method comprises receiving, by a message receiving client terminal, a message set to be displayed by a messaging user interface (UI) of the message receiving client terminal, identifying at least one ZW Unicode sequence in at least one in-text location between human lingual terms of textual content of the message, matching at least one in-text graphic element for the message based on the at least one ZW Unicode sequence, generating a decoded message by embedding the at least one in-text graphic element in the at least one in-text location between human lingual terms of textual content, and presenting the decoded message by a presentation unit of the message receiving client terminal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for generating an SMS and/or IM message with textual content and in-text graphic elements by encoding instructions to present the in-text graphic elements as zero width Unicode sequences and embedding the ZW Unicode sequences, according to some embodiments of the present invention;

FIG. 2 is a schematic illustration of a system for establishing a communication of SMS and/or IM messages with textual content embedded and in-text graphic elements, according to some embodiments of the present invention; and

FIG. 3 is a flowchart of a method for decoding an SMS and/or IM message with textual content embedded with zero width Unicode sequences, according to some embodiments of the present invention.

### DETAILED DESCRIPTION

The present invention, in some embodiments thereof, relates to messaging and, more specifically, but not exclusively, to encoding and decoding in-text graphic elements in short messages.

According to some embodiments of the present invention, there are provided methods and systems of generating messages, such as SMS and IM messages, with textual content, for example one or more sentences, embedded with zero width (ZW) Unicode sequence(s) indicative of instructions to create or select in-text graphic elements, such as emoticons, video files, audio files, animations, edited words or other terms and/or the like. Each ZW Unicode sequence is embedded in the textual content, for example inline before and/or after terms of the textual content. Each ZW Unicode sequence may be associated with a proximate term to allow replacing or editing the term by a decoder decoding the message. The encoding of instructions to create or select in-text graphic elements as ZW Unicode sequences facilitate sending messages which can be decoded by decoders which are not adapted to read the ZW Unicode sequences without losing textual data and/or while presenting the textual content of the message in a concise manner which is similar to the manner the textual content would have been presented when the ZW Unicode sequences are not embedded in the message.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

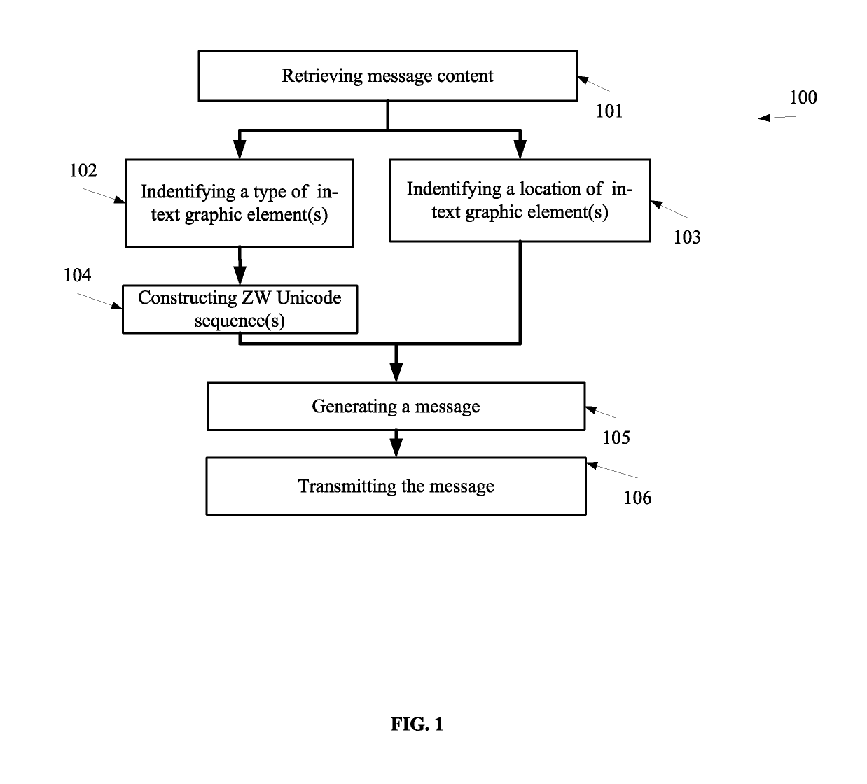

Reference is now made to FIG. 1, which is a method 100 for generating an SMS and/or IM message with textual content and instructions to create or select in-text graphic elements, such as graphics and/or emoticons, by encoding the instructions as ZW Unicode sequences and embedding the ZW Unicode sequences in line with terms of the textual content, for example between two words, according to some embodiments of the present invention. The in-text graphic elements may be independent graphic elements which are added after or before a specific human lingual term in the textual content, for instance emoticons, animations, audio files, video files, Universal Resource Identifiers (URI) and/or the like. The in-text graphic elements may be generated according to instructions which are applied to edit an associated specific human lingual term in the textual content, for example one or more words or a human expression from the textual content of the message, for instance instructions to edit the specific human lingual term or to replace it with an emoticon, an animation, an audio file, a video file, a URI and/or the like.

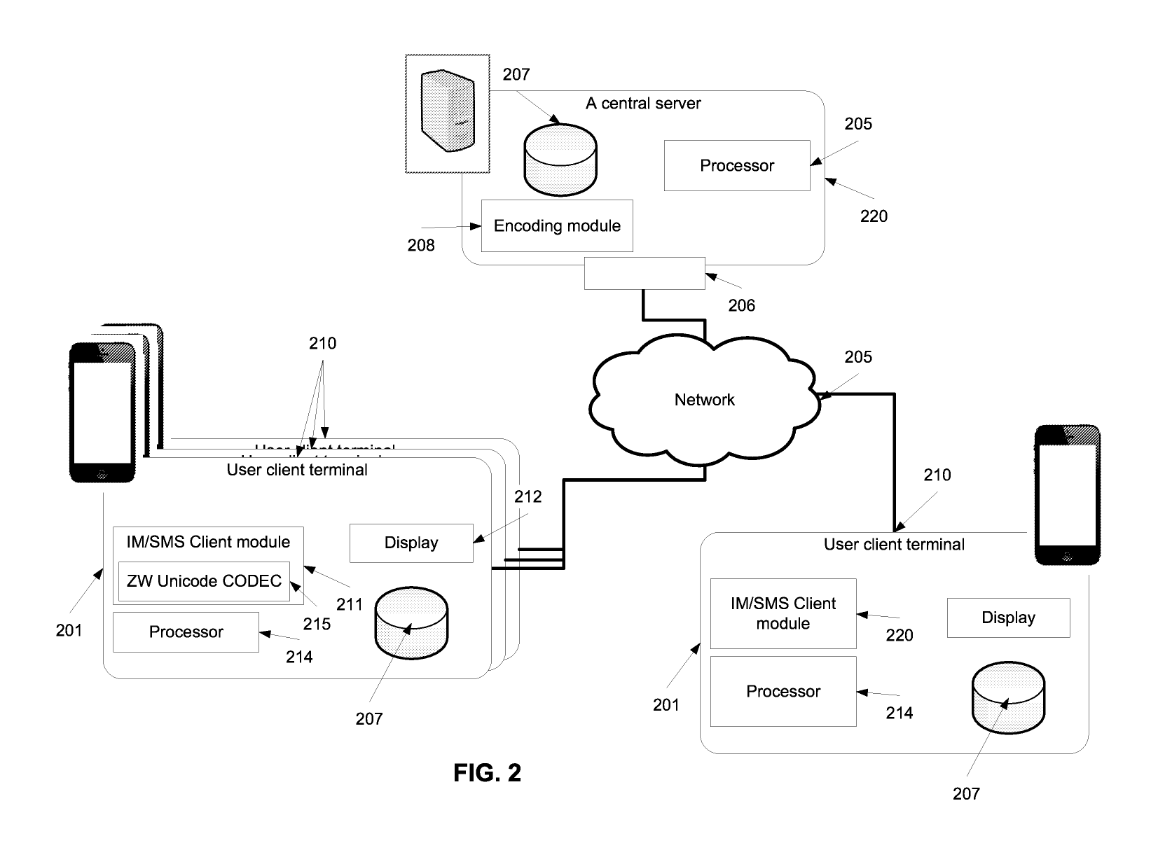

Reference is also made to FIG. 2, which is a schematic illustration of a system 200 for establishing a communication of SMS and/or IM messages with textual content embedded and instructions to create or select in-text graphic elements in a manner that the ability to decode the in-text graphic elements by one decoder does not reduce the ability to decode and concisely present the textual content without the in-text graphic elements by another decoder, according to some embodiments of the present invention.

The system 100 optionally allows embedding the zero width (ZW) Unicode sequences such that a decoding of the textual content of SMS and/or IM messages for a clear and concise presentation is facilitated with or without reading or executing the in-text graphic elements instructions.

The in-text graphic elements may be icons, emoticons, and/or graphical elements which are set to be presented in the text lines of the textual content, for instance instead of one or more linguistic human lingual terms of the textual content and/or before or after one or more linguistic human lingual terms. Additionally or alternatively, the in-text graphic elements are generated based on text enhancing instructions for editing one or more linguistic human lingual terms in textual content of the message, for example instructions to highlight, edit, curve, or color human lingual terms in textual content.

The system 100 includes an SMS/IM Client module 211 with a ZW Unicode encoder 212 sub module or an ability for generating ZW Unicode encoded messages based on data retrieved from a graphical user interface (GUI) that allows a user to input both textual content and in-text graphic elements. For example, the IM Client module 211 includes a GUI, such as a native SMS user interface, a native IM user interface, and/or any SMS or IM editor that allows a user to input textual content, for example by a keyboard (either real or virtual) or a keypad, and in-text graphic elements, for example from a palette and includes a ZW encoder for encoding in-text graphic elements in ZW Unicode sequences which are embedded in the textual content, for example in line between, before, or after selected human terms.

The IM Client module 211 is installed in a client terminal 201 having a processor 214 for executing the IM Client module 211, a memory for storing a conversion dataset or instructions 207 (referred to herein as conversion dataset) and a display 212, such as a cellular device, a tablet, a laptop, a wearable device and/or the like.

The system 200 optionally includes central unit 220, processor based 205, with an encoding module 208 installed thereon and includes an interface 206 for receiving requests and/or messages from the IM Client modules 211. The system 200 may be used a proxy for encoding messages with ZW Unicode sequences which are received from the IM Client modules 211 and/or for maintaining the conversion dataset 207 for converting in-text graphic elements to predefined ZW Unicode sequences and allowing access to the conversion dataset 207 via network 205, for example the internet.

In use, as shown at 101, a message content encoded as displayable data to be displayed by an SMS/IM GUI is retrieved from an SMS/IM GUI of the SMS/IM client module 211. The message content comprises text content and in-text graphic elements embedded in one or more text term locations, for example in a text line after or before words of the text content. The retrieving may be from a memory 207 of the user client terminal 210.

Now, as shown at 102, 103, the type and the location in-text graphic element(s) in the message are identified. The type identification of each in-text graphic element may be performed by identifying a representing number. The location of each in-text graphic element may be calculated based on a character distance from the outset of entry of the textual content. Optionally, the inline length of each in-text graphic element is calculated (e.g. from a preceding word to a succeeding word).

As shown at 104, one or more ZW Unicode sequence(s) are constructed for the one or more in-text graphic element(s), for example based on the above type identification. For instance, each digit of a number, a unique ID of an in-text graphic element, may be replaced with one of 4 ZW Unicodes such as (“\u200B”, “\u200C”, “\u200D”, “\ufeff”). Optionally, a unique ID representing each location in-text graphic element is converted to a quaternary numeral system representation, for instance one of the digits 0, 1, 2, and 3, facilitating a direct conversion to ZW Unicodes.

Optionally, the inline length of the ZW Unicodes is documented. For example, one or more ZW Unicodes are added to reflect the inline length of the in-text graphic element in a text line. The inline length may be deduced from a conversion dataset 207, for example by matching unique IDs of the in-text graphic element(s) with a respective record.

For example, each of “\u200B”, “\u200C” and “\u200D” denotes an in-text graphic element encoding inline length of 6, 12 and 18 respectively and the “\ufeff” Unicode indicates an additional inline length of 6 for each occurrence of the bit.

Optionally, when the inline length is less than 5, “\u200B” is used as a “length bit”, when the inline length is between 6 and 11 “\u200C” is used as a “length bit”, when the inline length is between 12 and 17 “\u200D” is used as a “length bit”, and when the inline length is more than 17, “\ufeff” is added to indicate additional 6 bits. 6 are subtracted from the image encoding inline length before a rechecking is performed.

Optionally, the ZW Unicode sequence is padded with leading ZW Unicodes “\u200B” until the inline length denoted by the length bits is reached. The padding allows encoding the ZW Unicode at a bit length so that the decoder at the client side can calculate how much to read. The padding is done with a Unicode mapped to a value 0 so the number remains unaffected.

Optionally, a ZW Unicode is added to the ZW Unicode sequence to indicate a termination of the ZW Unicode sequence. For example, the ZW Unicode “\u200B” also referred to as a delimiter bit is added as a suffix denoting the end of the ZW Unicode sequence. The delimiter bit is optionally added after a human lingual term which is set to be adjusted or replaced by in-text graphic element instructions which are encoded by the confining ZW Unicode sequence, for instance as exemplified below.

Now, as shown at 105, a message that includes the text content embedded with the unique ZW Unicode sequence(s) in the above identified location(s) is generated by embedding the ZW Unicode sequence(s) in the textual content, for instance by the ZW Unicode CODEC 215.

As shown at 106, the encoded message is transmitted to be read by a second client terminal which decodes the message for presentation of some or all of the message content.

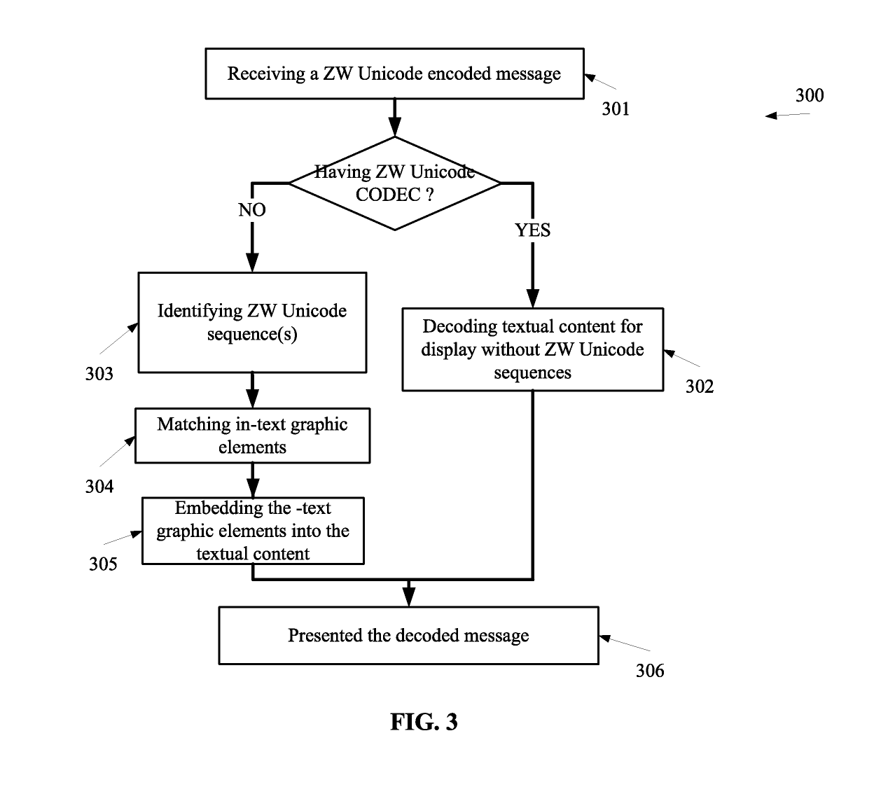

Reference is now made to FIG. 3, which is a flowchart of a process of a receiving a message having textual content embedded with ZW Unicode sequence(s), for instance messages encoded and transmitted as described above.

First, as shown at 301, a message generated as described above is received by the IM/SMS Client module 211 of the client terminal of a recipient of the encoded message. The IM/SMS Client module 211 may include a ZW Unicode encoder and/or decoder (CODEC) sub module 215 for encoding messages as described above and for decoding messages as described below. The IM/SMS Client module may not include such the ZW Unicode CODEC module 215, as described in 220.

As shown at 302, when the IM/SMS Client module of the receiving client does not have decoding capabilities, for example the ZW Unicode CODEC module 215, the textual content of the message is decoded and displayed in the original form.

This is an outcome of the encoding of the in-text graphic element(s) with ZW Unicode sequence(s) which are not presented when rendering the textual content of the message.

As shown at 303, when the IM/SMS Client module of the receiving client has decoding capabilities, for example the ZW Unicode CODEC module 215, the received message is reviewed for identifying ZW Unicode sequence(s) or portions thereof. Optionally, the ZW Unicode sequence(s) or portions are converted to identify a unique ID documented in the conversion dataset 207. For example, the conversion is performed as described herein. First, the inline length of each ZW Unicode sequence is identified, for example as follows:
characters of the message are read in a bitwise manner;
when the ZW Unicode is “\u200B” the respective in-text graphic element encoding inline length is 5;
when the ZW Unicode is “\u200C” the respective in-text graphic element encoding inline length is 11;
when the ZW Unicode is “\u200D” the respective in-text graphic element encoding inline length is 17; and
when the ZW Unicode is “\ufeff” the respective in-text graphic element encoding inline length is 6+the value of the next ZW Unicode (bit).

After the inline length is identified, the following ZW Unicodes (bits) are gathered into a string and the string is converted to form a unique ID. For instance, ZW Unicodes are mapped to 0, 1, 2 and 3 digits by a conversion to a decimal system, forming a unique ID mapped in the conversion dataset 207.

As shown at 304, in-text graphic elements are matched with data from the extracted ZW Unicode sequence, for example using the local or remote conversion dataset 207. An in-text graphic element may be retrieved using the unique ID.

Optionally, the delimiter bit is used to determine insertion area.

Now, as shown at 305, the in-text graphic elements are embedded into the textual content, forming displayable data to be displayed by a messaging UI of the SMS/IM Client module 211 of the receiving client terminal The textual content with the in-text graphic elements is optionally similar to the textual content with the in-text graphic elements which have been displayed by the UI of the SMS/IM Client module 211 of the transmitting client terminal.

As shown at 306, the decoded message is now presented, for example using the GUI of the SMS/IM Client module 211.

The above encoding and decoding facilitates the establishment of communication of messages with textual content and instructions to display in-text graphic elements which are either used to embed the in-text graphic elements in the presentation of the textual content or ignored when no suitable decoder is used or found by the receiving client module.

According to some embodiments of the present invention, an in-text graphic element is an edited version of a human lingual term from the textual content or an emoticon which replaces a human lingual term from the textual content. In such embodiments, the textual content includes the human lingual term and the ZW Unicode sequence is indicative of instructions to edit the human lingual term or instructions to replace the human lingual term with an emoticon, an animation, an image or a video which is associated therewith.

For example, when a client terminal retrieves a user message from a GUI with the text “Let's have coffee” and an indication to replace the word coffee with a graphical representation thereof, a unique ID indicative of a coffee cup animation, emoticon, or an image is decoded, for example the number 25. The unique ID is converted, using the conversion dataset 207, to a quaternary numeral system representation, for instance 25 is converted to 121. Each digit in the quaternary numeral system representation is converted to a ZW Unicode such that the string “\u200C\u200D\u200C” is formed. The inline length of the encoding is less than five so the length bit is set as “\u200B”. 2 more bits are added for padding so that the encoding reaches an inline length of 6 resulting in “\u200B\u200B\u200B\u200C\u200D\u200C”. Now the ZW Unicode sequence is added in the text, before the human lingual term, and a suffix ZW Unicode, the delimiter bit, is added after the term. In this example, the sent message is “Let's have \u200B\u200B\u200B\u200C\u200D\u200Ccoffee\u200B”. When decoding the message by a client module without a decoder such as the ZW Unicode CODEC module 215, the ZW Unicodes are not rendered and the text “Let's have coffee” is presented. When decoding the message by a client module with a decoder such as the ZW Unicode CODEC module 215, the ZW Unicodes and the word “coffee” are converted to present the coffee cup emoticon such that the following message is presented “Let's have ‘coffee cup emoticon’” is presented.

According to some embodiments of the present invention, the encoding of in-text graphic elements using the ZW Unicode sequences allows converting textual terms to different representations.

In one example, a simple text human lingual term which is marked with a ZW Unicode sequence, for example as described above, may be replaced with a colored, shaped, highlighted, enlarged, reduced in sized, animated, underscored and/or otherwise font adapted version of the marked human lingual term based on instructions matched when using the conversion dataset 207.

Additionally or alternatively, the simple text human lingual term marked with a ZW Unicode sequence, for example as described above, is associated with an audio and/or video file to be displayed with or without the presentation of the marked human lingual term based on instructions matched when using the conversion dataset 207. In such embodiments, a text message may be automatically converted to an audible or visual representation of its content, for example when all of the textual human lingual terms are converted to audible or visual versions thereof.

Additionally or alternatively, the simple text human lingual term marked with a ZW Unicode sequence, for example as described above, is associated with a hyperlink or any other Universal Resource Identifier (URI) to be used with or without the presentation of the marked human lingual term.

Optionally, the URI is used to acquire up-to-date dynamic data each time the message is presented at the recipient, for example sender location, meeting location.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a processor, a module, and a network is intended to include all such new technologies a priori.

As used herein the term “about” refers to ±10%.

The linguistic human lingual terms “comprises”, “comprising”, “includes”, “including”, “having” and their conjugates mean “including but not limited to”. This term encompasses the linguistic human lingual terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of embedding one or more zero width (ZW) Unicode sequence indicative of in-text graphic elements, comprising:
retrieving at a message transmitting client terminal a message content inputted by a user and encoded as displayable data to be displayed by a messaging user interface (UI) of said message transmitting client terminal, said message content comprises text content and at least one in-text graphic element to be embedded in line before, after or between human terms in said text content;
automatically identifying at least one in-text location of said at least one in-text graphic element in said text content;
automatically identifying at least one ZW Unicode sequence associated with said at least one in-text graphic element;
encoding a message that includes said text content and embeds said at least one ZW Unicode sequence in said at least one in-text location; and
transmitting said message to a message receiving client terminal which decodes said at least one ZW Unicode sequence for a presentation of said at least one in-text graphic element embedded in said textual content.

2. The method of claim 1, wherein said retrieving is performed from a graphical user interface of said message transmitting client terminal which displays said at least one in-text graphic element embedded in said at least one in-text location of said textual content.

3. The method of claim 1, wherein said at least one ZW Unicode sequence is indicative of instructions to replace at least one human lingual term of said text content with said in-text graphic element at least at least one in-text location.

4. The method of claim 1, wherein said in-text graphic element is selected from a group consisting of a video file, an audio file, a Universal Resource Identifier (URI) element, an image, and an animation.

5. The method of claim 1, wherein said at least one ZW Unicode sequence is indicative of instructions to replace at least one human lingual term of said text content with an edited version of said at least one human lingual term.

6. The method of claim 5, wherein said edited version is at least one of a colored version of said at least one human lingual term, a highlighted version of said at least one human lingual term, an animated version of said at least one human lingual term, and a sized amended version of said at least one human lingual term.

7. The method of claim 1, wherein said at least one ZW Unicode sequence comprises a first segment which precedes confines at least one human lingual term of said text content and a second segment which succeeds said at least one human lingual term in said text content; wherein when a decoder of said message receiving client terminal reads said at least one ZW Unicode sequence said at least one lingual term is converted to a presentation of said at least one in-text graphic element in said at least one in-text location and when said decoder does not read said at least one ZW Unicode sequence, said at least one lingual term is presented in said at least one in-text location in said text content without presenting said at least one ZW Unicode sequence and said at least one in-text graphic element.

8. The method of claim 1, wherein said transmitting is performed so that when said message is decoded by a decoder set to read said at least one ZW Unicode sequence said at least one in-text graphic element is identified and presented on a display of said message receiving client terminal.

9. The method of claim 8, wherein when said message is decoded by another decoder not set to read said at least one ZW Unicode sequence, said textual content is presented without said at least one in-text graphic element and without visually presenting said at least one ZW Unicode sequence.

10. The method of claim 1, wherein said encoding comprises:
identifying an inline length of said at least one in-text graphic element and adding at least one Unicode representing said inline length to said ZW Unicode sequence; and
wherein said inline length is used for said decoding.

11. The method of claim 10, wherein said encoding comprises padding said ZW Unicode sequence with at least one designated Unicode based on said ZW Unicode sequence.

12. A computer readable medium comprising computer executable instructions adapted to perform the method of claim 1.

13. A system of embedding one or more zero width (ZW) Unicode sequences indicative of in-text graphic elements comprising:
a graphical user interface for retrieving a message content inputted by a user and encoded as displayable data to be displayed by a messaging user interface (UI) of said message transmitting client terminal, said message content comprises text content and at least one in-text graphic element to be embedded in line before, after or between human terms in said text content;
a client module encoder which identifies automatically at least one in-text location of said at least one in-text graphic element in said text content and at least one ZW Unicode sequence associated with said at least one in-text graphic element, said client module encoder encodes a message that includes said text content and embeds said at least one ZW Unicode sequence in said at least one in-text location; and
a network interface which transmits said message to a message receiving client terminal which decodes said at least one ZW Unicode sequence for a presentation of said at least one in-text graphic element embedded in said textual content.

14. A method of decoding in-text graphic elements from a message comprising:
receiving, by a message receiving client terminal, a message set to be displayed by a messaging user interface (UI) of said message receiving client terminal;
identifying at least one ZW Unicode sequence in at least one in-text location between human lingual terms of textual content of said message;
matching at least one in-text graphic element for said message based on said at least one ZW Unicode sequence;
generating a decoded message by embedding said at least one in-text graphic element in said at least one in-text location between human lingual terms of textual content;
presenting said decoded message by a presentation unit of said message receiving client terminal.
